(19) United States
(12) Patent Application Publication
(10) Pub. No.: US 2014/0305170 A1
(43) Pub. Date: Oct. 16, 2014

(54) SUPERCRITICAL FLUID SPECTOMETER APPARATUS

(71) Applicant: Applied Separations, Inc., Allentown, PA (US)

(72) Inventors: Martin J. FETNER, Allentown, PA (US); Howard L. MARK, Suffern, NY (US)

(73) Assignee: Applied Separations, Inc., Allentown, PA (US)

(21) Appl. No.: 14/252,468

(22) Filed: Apr. 14, 2014

Related U.S. Application Data
(60) Provisional application No. 61/811,458, filed on Apr. 12, 2013.

(51) Int. Cl. D06B 23/10; G01N 21/25

(52) U.S. Cl. CPC D06B 23/10; G01N 21/255
USPC 68/12.07; 250/227.11

(57) ABSTRACT

A system for monitoring and obtaining spectral data from a supercritical fluid process. The system includes a process vessel containing a supercritical fluid, a light source, and a spectrometer. Sampling light emitted by the light source is transmitted into the internal cavity of the process vessel and reflected back to the spectrometer for processing and analysis. The reflected sampling light includes spectral data about the supercritical fluid, thereby allowing process parameters such as the concentration levels of the fluid in the vessel to be generated and monitored for determining the progress of the reaction. Carbon dioxide may be used as the supercritical fluid. In one embodiment, the system may be used in a supercritical fluid textile dyeing process to monitor the progress of the textile colorization.

### CROSS-REFERENCE TO RELATED APPLICATIONS

The present application claims priority to U.S. Provisional Application No. 61/811,458 filed Apr. 12, 2013, the entire contents of which are incorporated herein by reference.

### BACKGROUND OF THE DISCLOSURE

The present disclosure generally relates to supercritical fluid reaction and extraction processes, and more particularly to spectral monitoring system for monitoring the reaction in such processes.

Supercritical fluid reaction and extraction utilizes a supercritical fluid such as CO2 (carbon dioxide) are characterized by cost effectiveness and relatively low toxicity in comparison to other conventional methods used for the same purposes. Such reaction/extraction processes may include using supercritical fluid CO2 as a solvent for extracting a component of interest from a matrix material, in manufacturing products such as foams or carbonates, and as a dye carrier for the coloration of materials such as textile fabrics. in a supercritical fluid CO2 reaction/extraction systems, the usual parameters that are measured and controlled are pressure, temperature, flow rate, and time.

Monitoring of other process parameters however may be beneficial particularly for some applications of supercritical fluid processes.

### SUMMARY OF THE DISCLOSURE

A spectral monitoring system according to the present disclosure provides monitoring of an additional parameter of a supercritical fluid process that may be critical to determine the process's progress and effectiveness, spectra. The supercritical fluid may be CO2 in one embodiment; however, other suitable supercritical fluids may be used. In one non-limiting application, the present spectral monitoring system may be used in a supercritical fluid fabric dyeing process to determine the progress and completion of the material coloration.

In one embodiment, a spectral monitoring system includes: a process vessel defining an internal cavity containing a supercritical fluid; a sealed window mourned to the process vessel, the window having a line of sight into the internal cavity; a reflecting mirror disposed in the internal cavity of the process vessel, the mirror axially aligned with the line of sight of the window; a light source configured to emit sampling light; a spectrometer configured to process spectral data; a fiber optic cable comprising light illuminating fibers and light collecting fibers; a first end of the fiber optic cable disposed adjacent the window; and a second end of the fiber optic cable being bifurcated between the illuminating fibers optically coupled to the light source and the collecting fibers optically coupled to the spectrometer. The sampling light from the light source passes from the fiber optic cable through the window, strikes and is reflected by the mirror back through window into the fiber optic cable, and is received by the spectrometer for processing.

In another embodiment, a spectral monitoring system includes: a cylindrical vessel closure having a threaded sidewall configured to removably engage a threaded port formed in a process vessel containing a supercritical fluid; an axial bore extending through the vessel closure and defining an optical axis; a sealed window mounted to the vessel closure in axial alignment with the bore: a reflecting mirror mounted to the vessel closure in spaced apart relationship and axially aligned with the bore and window; a light source configured to emit sampling light; a spectrometer configured to receive and process spectral data; a fiber optic cable comprising light illuminating fibers and light collecting fibers; a first portion of the fiber optic cable inserted through the axial bore; a second portion of the fiber optic cable being bifurcated between the illuminating fibers optically coupled to the light source and the collecting fibers optically coupled to the spectrometer. The sampling light from the light source passes from the fiber optic cable through the window, strikes and is reflected by the mirror back through window into the fiber optic cable, and is received by the spectrometer for processing.

In one embodiment, a textile dye system with spectral monitoring includes: a flow loop comprising a primary dye vessel containing a fabric, a dye recirculation pump, and a secondary dye absorbance monitoring vessel containing a fabric sample for monitoring the color saturation of the fabric; a supercritical fluid circulating through the flow loop; a cylindrical vessel closure removably coupled to the primary dye vessel; an axial bore extending through the vessel closure and defining an optical axis; a glass window mounted to the vessel closure in axial alignment with the bore; a reflecting mirror mounted to the vessel closure in spaced apart relationship and axially aligned with the bore and window; a light source configured to emit sampling light; a spectrometer configured to receive and process spectral data; a fiber optic cable comprising light illuminating fibers and light collecting fibers; a first portion of the fiber optic cable inserted through the axial bore; a second portion of the fiber optic cable being bifurcated between the illuminating fibers optically coupled to the light source and the collecting fibers optically coupled to the spectrometer. The sampling light from the light source passes from the fiber optic cable through the window, strikes and is reflected by the mirror back through window into the fiber optic cable, and is received by the spectrometer for processing.

A method for obtaining spectral data from a supercritical fluid process is provided. In one embodiment, the method includes: providing, a process vessel defining an internal cavity containing a supercritical fluid, a light source emitting sampling light, and a spectrometer; transmitting the sampling light through a sealed window in the process vessel into the internal cavity; striking a reflector disposed in the internal cavity with the sampling light; returning reflected sampling light back through the window in the process vessel, the reflected sampling light containing spectral data from the supercritical fluid; receiving the reflected sampling light by the spectrometer; and the spectrometer processing the spectral data.

### BRIEF DESCRIPTION OF THE DRAWINGS

The features of the exemplary embodiments will be described with reference to the following drawings, where like elements are labeled similarly, and in which:

FIG. 1 is a system diagram of a spectral monitoring system for a supercritical fluid process including a side cross sectional view of a removable vessel closure of the system;

FIG. 2 is an end view of the vessel closure;

FIG. 3 is a system diagram of a supercritical fluid textile dyeing process including the spectral monitoring system of FIG. 1;

FIG. 4 is a graph showing actual concentration levels of CO2 supercritical fluid versus pressure at a first temperature; and

FIG. 5 is a graph showing actual concentration levels of CO2 supercritical versus pressure at a second temperature.

All drawings are schematic and not necessarily to scale.

### DESCRIPTION OF EXEMPLARY EMBODIMENTS

The features and benefits of the invention are illustrated and described herein by reference to exemplary embodiments. Accordingly, the disclosure expressly should not be limited to such exemplary embodiments illustrating some possible non-limiting combination of features that may exist alone or in other combinations of features. This description of exemplary embodiments is intended to be read in connection with the accompanying drawings, which are to be considered part of the entire written description.

In the description of embodiments disclosed herein, any reference to direction or orientation is merely intended for convenience of description and is not intended in any way to limit the scope of the present invention. Relative terms such as “lower” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” and “interconnected,” refer to a relationship wherein structures are secured or attached to one another either directly or indirectly through intervening structures, as well as both movable or rigid attachments or relationships, unless expressly described otherwise.

“Software”, as used herein, includes but is not limited to, one or more computer instructions and/or processor instructions that can be read, interpreted, compiled, and/or executed by a computer and/or processor. Software causes a computer, processor, or other electronic device to perform functions, actions and/or behave in a desired manner. Software may be embodied in various forms including routines, algorithms, modules, methods, and/or programs. In different examples software may be embodied in separate applications and/or code from dynamically linked libraries, in different examples, software may be implemented in executable and/or loadable forms including, but not limited to, a stand-alone program, an object, a function (local and/or remote), a servelet, an applet, instructions stored in a memory, part of an operating, system, and so on. In different examples, computer-readable and/or executable instructions may be located in one logic and/or distributed between multiple communicating, co-operating, and/or parallel processing logics and thus may be loaded tor executed in serial, parallel, massively parallel and other manners. Software is fixed in a tangible medium.

A spectral monitoring system according to the present disclosure provides an optical window that can look at the fluid circulating inside a process vessel containing a supercritical fluid like CO2 (carbon dioxide), or a mixture of CO2 and a modifier, and measure. the wavelength and amplitude of the fluid as the reaction/extraction progresses. This optical window can be used to investigate any part of the spectrum that a particular spectral detector would be sensitive to, such as without limitation IR (infrared), NIR (near infrared), UV (ultraviolet), visible, microwave, etc. Raman and Fluorescence spectroscopy techniques may also be used in application of the present invention.

In one embodiment, the spectral monitoring system is capable and operable to measure supercritical CO2 under different conditions, such as varying temperatures and pressures (e.g. up to 5000 psi, or more).

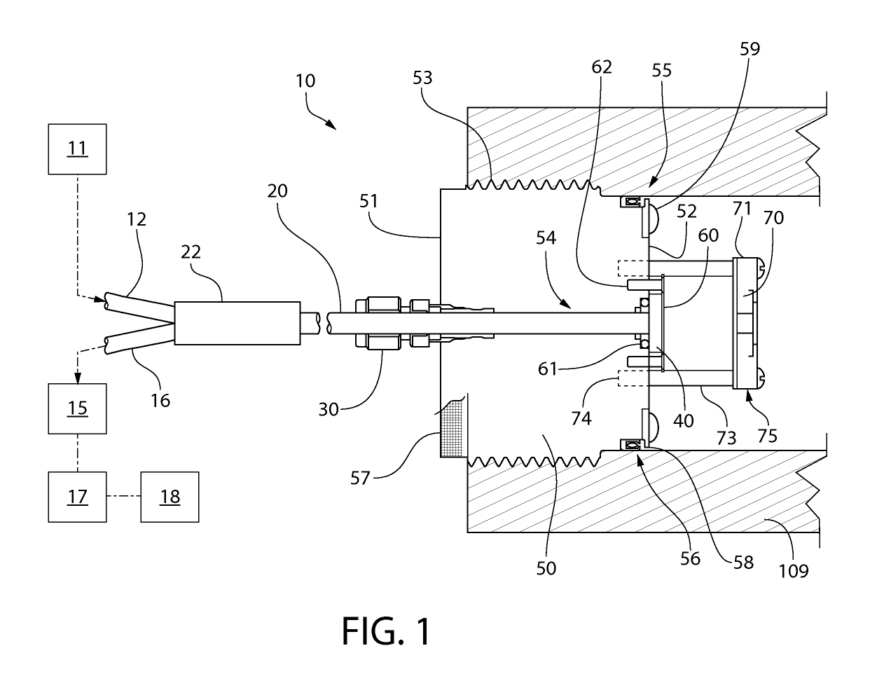

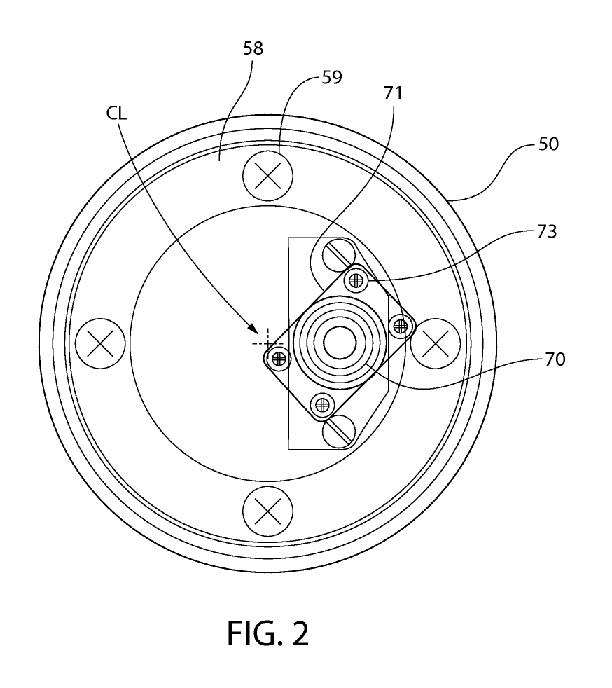

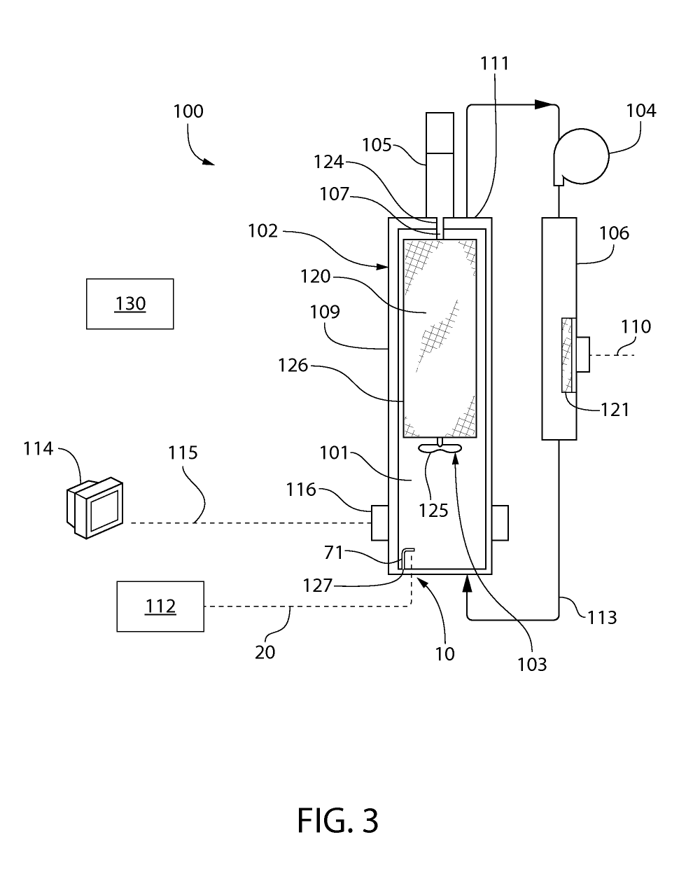

FIGS. 1 and 2 depict a spectral monitoring system according to the present disclosure. The spectral monitoring system 10 includes a vessel closure 50 defining an axial bore 54 which receives a fiber optic cable 20 carrying a combination of illuminating fibers 12 and light collecting fibers 16 therein. The axial bore 54 extends completely through the vessel closure 50 and visually communicates with the internal cavity 101 of a process vessel 109 (see also FIG. 3) to provide an Observation window and line of sight into the vessel for obtaining spectral information, as further described herein. Axial bore 54 defines an optical axis. In one non-limiting exemplary embodiment, vessel closure 50 may have a cylindrical configured with circular transverse cross-section. Bore 54 may be positioned concentrically with an axial centerline CL defined by vessel closure 50, or may be offset from the centerline (as shown in FIG. 2). Either arrangement may be used.

Vessel closure 50 may be made of any suitable metal or metal alloy capable of withstanding the temperatures and pressures inside the process vessel 102 to which it is mounted. In one example, steel may be used.

The fiber optic cable 20 extends through the bore 54 from the exterior surface 51 of the vessel closure 50 and terminates at one end adjacent to and preferably pressed against an optically transparent window 40 mounted to the interior surface 52 (i.e. pressure side) of the closure. In one embodiment, the window 40 may be a sapphire window constructed to withstand the internal pressure within the process vessel 102. In one exemplary construction, the window 40 may be structured to withstand 10,000 psi (internal process vessel pressure). Window 40 may have any suitable thickness or shape, including circular in one embodiment.

In one embodiment, window 40 may be mounted in or on the interior surface 52 of the vessel closure 50 by a stainless steel spring clip 60, thereby forming a transparent pressure barrier that prevents pressurization of axial bore 54 in vessel closure 50. Other materials may be used. In one embodiment, the spring clip 60 may be mounted to the vessel closure 50 by a plurality of space apart threaded fasteners 62 or other suitable means. When pressurized CO2 is present in the process vessel 102, the pressurized CO2 bears against the window 40 and aids in sealing, it to the closure 50. The clip 60 is preferably configured to hold and support the window along its peripheral edge to allow a clear optical path (line of sight) into the internal cavity 101 of the process vessel 102. A seal 61 such as an O-ring may be provided that is mounted in a recess in the interior surface 52 of the vessel closure 50. Seal 61 operates to engage and seal the window 40 against the vessel closure (best shown in FIG. 1).

A bifurcated second end fiber optic cable 20 is split between the illuminating fibers 12 coupled to light source 11 and collecting fibers 16 coupled to spectrometer 15, as further described herein.

The fiber optic cable 20 is inserted and fitted through axial bore 54 in the vessel closure 50. In one embodiment, the fiber optic cable 20 may be mounted to vessel closure 50 and held in place by a commercially available cable fitting 30 such as without limitation a Swagelok™ type tube fitting. The fitting 30 may have a threaded NPT end to engage mating internal threads inside bore 54 and an opposite end with a tube fitting end configured to compressibly engage and retain the fiber optic cable 2. It will be appreciated that other suitable type fitting may be used to couple the fiber optic cable 20 to the vessel closure 50. Fiber optic cable 20 may include any suitable number of illuminating fibers 12 and collecting fibers 16. In one non-limiting exemplary embodiment, four illuminating fibers and three collecting fibers may be provided. The illuminating fibers 12 and collecting fibers 16 are contained with a single outer sheath of fiber optic cable 20 for at least the extent and portion that is inserted through vessel closure 50 and cable fitting 30 (best shown in FIG. 1). The illuminating fibers 12 and collecting fibers 16 may be bifurcated at a point at splitter coupling 22 and routed separately within their own outer sheaths to their respective other components of the spectral monitoring system 10, as further described herein. Any suitable type of commercially available fiber optic cable and fibers may be used which are operable to transmit light.

The vessel closure 50 is configured to be coupled to the process vessel 102 in a sealed manner that prevents leakage of the pressurized contents (i.e. CO2 fluid and other constituents in the fluid) outwards from the vessel. In one embodiment, an annular seal 56 mounted between the vessel closure and interior surface of the process vessel 102 adjacent the interior surface 52 of the closure may provide the sealed coupling mechanism as shown in FIG. 1. Seal 56 may be held in place by a retaining ring 58 which may be bolted to interior surface 52 of vessel closure 50 by fasteners 59 (see also FIG. 2). Any suitable seal may be used, including a U-shaped cup seal, O-rings, metal reinforced O-rings, or other depending on the process pressure and temperature in the process vessel 102. It is well within the ambit of those skilled in the art to select an appropriate type seal.

In one embodiment, the vessel closure 50 may be configured to be removably coupled to the process vessel 102 such as via externally threaded sidewalls 53 which engage mating internal threads formed inside an open port 55 of the process vessel 102 extending into the internal cavity 101 (best shown in FIG. 1). The vessel closure 50 may be mounted at any suitable location on the process vessel 102. In various embodiments, the vessel closure 50 may have a smaller diameter than and be mounted on either of the end caps or walls 111. In some embodiments, the vessel closure 50 may form the end cap or wall 111 itself as shown for example in FIG. 1. In other embodiments, the vessel closure may be mounted to the cylindrical sidewall 109. Mounting the vessel closure 50 with fiber optic cable 20 into the sidewall 109 of the process vessel 102 instead of the end walls 111 or as the end wall would allow for the measurement of the vessel's contents at various heights in the vessel. This might be advantageous if the depth of the CO2 fluid may influence the readings.

In alternative embodiments, the axial bore 54 may be formed directly through one of the walls of the process vessel 102 in lieu of a removable vessel closure 50. In such constructions, the fiber optic cable 20, window 40, and reflecting mirror 70 may therefore instead be mounted directly into and/or on the process vessel 102. The invention is expressly not limited to any of the foregoing arrangements or mounting positions of the spectral monitoring system.

As best shown in FIG. 1, the exposed outermost portion of vessel closure 50 (when mounted to process vessel 102) adjacent the exterior surface 51 may have a surface texture 57 (e.g. knurling, ridges, etc.) to facilitate rotating and threading the closure into the threaded port 55 of process vessel 102.

With continuing reference to FIGS. 1-3, axially aligned with the window 40 inside the process vessel 102 is a spherical reflecting mirror 70. Any suitable commercially available mirror 70 may be used. Mirror 70 is spaced apart and separated from the window 40 and interior surface 52 of vessel closure 50 by a gap formed by one or more stand-oils 73. The stand-offs 73 may be adjusted to vary the gap and focus sampling light (emitted from one end of the fiber optic cable 20 via the illuminating fibers 12 into the internal cavity 101 of process vessel 102) which is reflected back from mirror 70 through the window to the collecting fibers 16. This arrangement allows a spectrometer to observe the CO2 and a modifier that may be used passing between the window and the mirror to be measured. The modifier is optional and may be any type solution that will assist the progress of the reaction (e.g. methanol, etc.). In one embodiment, the stand-offs 73 may be threaded fasteners (e.g. screws or bolts) which are threadably engaged with threaded sockets 74 formed through interior surface 52 into vessel closure 50. Sockets 74 have a suitable depth to permit adjusting the spacing between the mirror and vessel closure by rotating the fasteners.

In one embodiment, the reflecting mirror 70 may be mounted in a bracket 75 comprised of a relatively flat metal mounting plate 71 configured to fixedly hold the mirror and the stand-offs 73. The stand-offs 73 extend through openings formed through the plate 71. In one configuration, four adjustable stand-offs 73 may be provided that are mounted to the plate 71 at each of four corners of the plate in a rectilinear configuration of the plate. This arrangement ensures that the stand-offs do not interfere with light shined onto and reflected back from the mirror 70 through window 40 of the vessel closure 50. Other suitable polygonal and non-polygonal shapes of plates 71 may be used (e.g. circular, oval, triangular, etc.) with a suitable number of stand-offs 73.

An application of this invention in the cloth dyeing industry is being considered. Here the device would use the visible spectrum to look at the color of soluble dye in supercritical CO2. Another use would be to look at the color deposited on the cloth mounted against the sapphire window. This would be an indication that the dyeing process was approaching completion.

Referring to FIG. 1, the spectral monitoring system 10 further includes a light source 11 for generating spectral signals from and data about the progress of the chemical reaction in the process vessel 102. Any suitable wavelength of light may be used, including without limitation IR, NIR, UV visible, microwave, etc. that can be detected by the spectrometer. Any suitable commercially available light source 11 may be used for this purpose. In one example, the light source may a tungsten halogen light source (bulb) such as Model BPS120 available from BWTEK™ of Newark, Del. having a spectral range from 350 to >2600 nm. The emitted light is transmitted from the light source 11 through the illuminating fibers 12 of the fiber optic cable 20 to the vessel closure window 40 and into the internal cavity 101 of the process vessel 102 to the reflecting mirror 70.

Spectral monitoring system 10 further includes a spectrometer 15. As an input, spectrometer 15 receives reflected light transmitted via collecting fibers 16 from reflecting mirror 70 which provides spectral data for processing and analysis regarding the reaction in process vessel 102. Any suitable commercially-available spectrometer may be used. In one non-limiting example, the spectrometer 15 may be a Sol™ with thermoelectric cooled InGaAs photodiode array detector available from BWTEK™. In one embodiment, the detector may be configured to receive and measure light reflection emitted by light source 11 in the NIR (near infrared) range of 1200-1700 nm. Other suitable wavelengths of light sources and detector wavelength sensitivity may be used depending on the wavelength of the light.

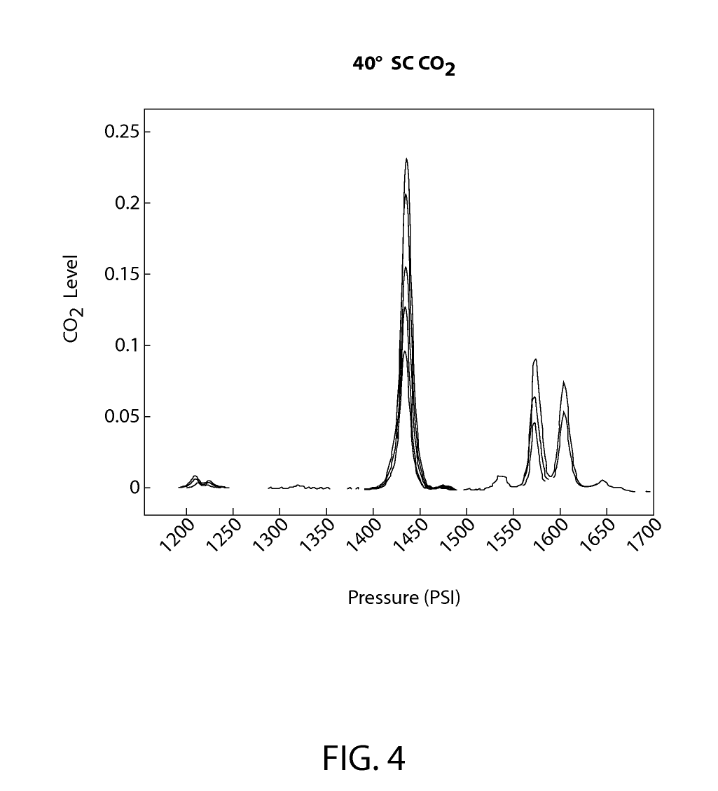

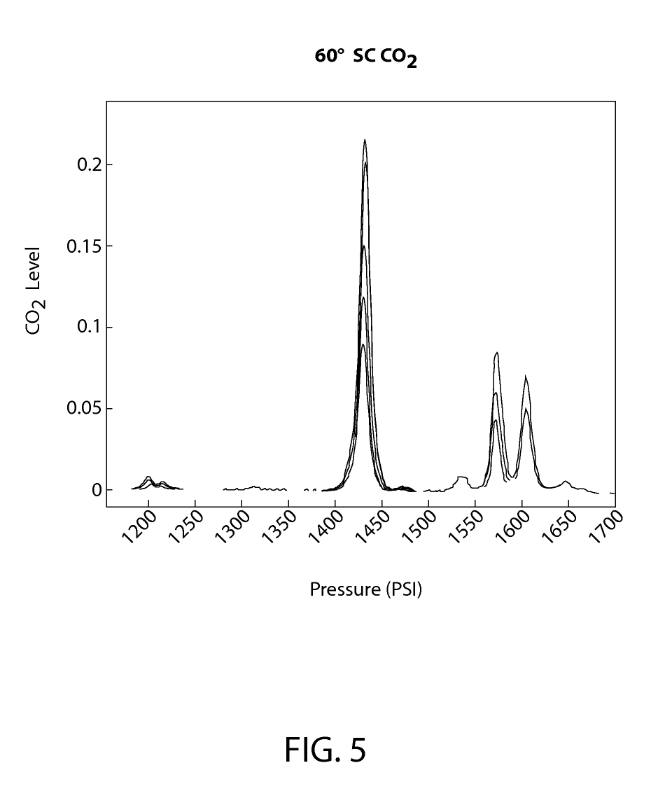

The spectral monitoring system 10 system may include a programmable computer processor 17 running spectral data acquisition and processing software, such as without limitation BW Spec™ available from BWTEK™. The software is operable to receive, process, analyze, and output spectral data acquired for display and provides a user interface with the spectrometer. Using the software which is executed and directs the operation of the computer processor 17, the spectral data and results acquired by the spectral monitoring system 10 may be displayed on a visual display monitor 18 in the form of graphs and/or data. FIGS. 4 and 5 illustrate some examples of such displayed information actually acquired in a test of the spectral monitoring system 10. The graphs show variation in the measurement of CO2 levels versus pressure inside the process vessel 102 with changes in temperatures (i.e. 40° C. and 60° C.) illustrated in the two different graphs. CO2 concentrations (units of absorbance) as shown on the vertical axis and pressures (psi) are shown in the horizontal axis of the graphs.

Computer processors such as computer processor 17 are well known to those skilled in the art and includes various electronic components necessary for a fully functional processor system, some of which are described below. The computer processor 17 may be connected to a wired or wireless communication infrastructure (e.g., a communications bus, cross-over bar, local area network (LAN), or wide area network (WAN)). Processor(s) may be any central processing unit, microprocessor, micro-controller, computational device, or like device that has been programmed to form a special purpose processor for performing the computer functions. In some embodiments, processor(s) may be configured to run a multi function operating system.

Memory provided with computer processor 17 may be a local or working memory, such as, a random access memory (RAM) while secondary memory may be a more persistent memory. Examples of secondary memory include, but are not limited to, a hard disk drive(s) and/or removable storage drive(s) representing a floppy disk drive, a magnetic tape drive, an optical disk drive, or the like. A removable storage drive, if employed, may read from and/or write to a removable storage unit. Removable storage unit(s) may be a floppy disk, magnetic tape, CD-ROM, DVD-ROM, optical disk, ZIP™ drive, Blu-Ray disk, and the like, which may be written to and/or read by a removable storage drive. In some embodiments, secondary memory may include other similar devices for allowing computer programs or other instructions to be loaded into a computer, such as, a removable storage device and an interface. An example of such a removable storage device and interface includes, but is not limited to, a USB flash drive and associated USB port, respectively. Other removable storage devices and interfaces that allow software and data to be transferred from the removable storage device to a computer may be used.

Computer processor 17 may further include a communications interface that allows software and data to be transferred between a computer and external devices. Examples of communications interface may include a modem, a network interface (such as an Ethernet or wireless network card), a communications port, a Personal Computer Memory Card International Association (PCMCIA) slot and card, or the like. Software and data transferred via a communications interface are in the form of signals which may be electronic, electromagnetic, optical, or any other signal capable of being received by the communications interface. These signals are provided to the communications interface via a communications path or channel. The path or channel that carries the signals may be implemented using wire or cable, fiber optics, a telephone line, a cellular link, a radio frequency (RF) link, or the like.

It will be understood that operation and control aspects of the present invention may therefore be embodied in the form of computer-implemented processes and apparatus for practicing those processes. Aspects of the present invention with respect to software comprised of processor/computer program instructions or control logic configured to receive and process the spectral data obtained by spectral monitoring system 10 described herein may be embodied in tangible computer readable non-transitory storage media encoded with computer program code or instructions, such as random access memory (RAM), floppy diskettes, read only memories (ROMs), CD-ROMs, ZIP™ drives, Blu-Ray disks, hard disk drives, flash memories, or any other machine-readable storage medium, such that when the computer program code is loaded into and executed by a computer, the computer becomes a particular machine for practicing the invention. When implemented on a general-purpose processor, the computer program code segments configure the processor to create specific logic circuits. The invention may alternatively be embodied in a digital signal processor formed of application specific integrated circuits (ASICs) for performing a method according to the principles of the invention.

Computer processor 17 should therefore be broadly construed to include any of the foregoing electronic devices and processor system related components and others not specifically enumerated herein which are known to those skilled in the art to provide a fully functional system.

Operation of the spectral monitoring system 10 will now be briefly summarized. In operation, light source II emits sampling light which is conveyed in the illuminating fibers 12 via fiber optic cable 20 to the vessel closure 50. The light is transmitted through window 40 and strikes reflecting mirror 70. The reflected sampling light is returned through the CO2 fluid stream flowing between the reflecting mirror and window, thereby acquiring spectral data about the fluid and progress of the reaction inside process vessel 102. The reflected light travels back through window 40 and is received by the collecting fibers 16 in fiber optic cable 12. The collecting fibers 16 convey the light to the spectrometer 15 which outputs the data to computer processor 17 for analysis. The computer processor 17 outputs and displays the spectral data on the visual display device 18 for review by a user.

FIG. 3 depicts one non-limiting example of the spectral monitoring system 10 disclosed herein as applied in a supercritical fluid textile dye system 100. In one embodiment, the supercritical fluid may be CO2 which acts as the dye carrier. This is especially effective in the dyeing of polyester fabrics. The spectrometer 15, computer processor 17, and visual display device 18, etc. are collectively shown schematically in the box labeled 112 for brevity and clarity.

The textile dye system 100 includes in fluid communication (along the flow path) a primary process vessel 102 which may be considered a primary dye vessel (PDV), dye recirculation pump 104, dye absorbance monitoring vessel 106 which may be considered a secondary dye vessel (SDV) containing a fabric sample 121 to monitor dye/color saturation of fabric, and dye take-up vessel 108. The dye and CO2 fluid mixture flows in accordance with the directional flow arrows shown. These dye system components may be fluidly connected via suitable piping 113 (and/or tubing) represented by the flow path lines which formed a close supercritical fluid flow loop. The primary dye vessel in this example may be a nominal 5 liter capacity vessel having approximately a 4.5 inch diameter and 16 inch internal length. The working pressure and temperature may be 6,000 psi and 150° C.

The PDV may have a plurality of ports for numerous inputs and outputs. The PDV (process vessel 102) may include the following. One or multiple view ports 116 to view the dyeing process inside the vessel. One view port 116 may be illuminated with a fiber optic endoscope and images obtains can be viewed on an associated display monitor 114 (touchscreen) operably coupled via a fiber optic cable 115.

A stirrer port 124 in one of the threaded end caps or walls 111 may be provided to accommodate a stirrer 103. Stirrer 103 may include an electric motor drive 105 which rotates a drive shaft 107 coupled at one end to the drive and having an impeller 125 at an opposite end immersed in the PDV. Stirrer 103 may have drive shafts 107 of varying length shafts and a variety of impellers 125 depending on the size/capacity of the PDV and processes parameters. A stirring basket 126 may be provided in which fabric can be placed for dyeing. The stirrer 103 may be controlled at a control touch panel of a processor-based dye system process controller 130. The controller 130 may also communicate with, control, and monitor the operation of the various textile dye vessel system 100 components shown and described, and provides a user interface. The controller 130 may be configured and include various electronic components similarly to computer processor 17 described herein.

Bore 54 of the spectral monitoring system (see also FIG. 1) may provide a spectrophotometer port in the threaded end cap or wall 111 opposite the stirrer port 124. This allows for UV, visible, near IR, or IR transmission and absorbance measurements though the fiber optic probe 20 as described herein.

The secondary dye vessel or SDV (dye absorbance monitoring vessel 106) may be a nominal 1 liter vessel in one embodiment having approximately a 3 inch diameter and 9 inch internal length. The working pressure and temperature of the SDV may be about 10,000 psi pressure and 240° C. The SDV may include some or all of the features and components of the PDV (primary process vessel 102). Accordingly, one or both threaded end caps or walls 11 on the SDV may each on the vessel each have five ports for numerous inputs and outputs.

The SDV may operably communicate with process controller 130, or a separate dedicated controller.

An exemplary method for obtaining spectral data from a supers fluid process will now be described. The method may include: providing, a process vessel 102 defining an internal cavity 101 containing a supercritical fluid (e.g. CO2), a light source 11 emitting sampling light, and a spectrometer 15 transmitting the sampling light through a sealed window 40 in the process vessel into the internal cavity; striking, a reflector 70 disposed in the internal cavity with the sampling light; returning reflected sampling light back through the window in the process vessel, the reflected sampling light containing spectral data from the supercritical fluid; receiving the reflected sampling light by the spectrometer; and the spectrometer processing the spectral data. The method may further include a computer processor 17 analyzing the spectral data and displaying the spectral data on a visual display device 18. The display spectral data may include the concentration of supercritical fluid (e.g. CO2) in the process vessel. In one embodiment, the reflecting mirror is spaced apart from an interior surface of the process vessel. The window and reflecting mirror may be axially aligned along a first optical axis. The window and reflecting mirror may be supported by and mounted to a removable vessel closure 50 which is threadably engaged in an open port 55 of the process vessel. In one embodiment, the process vessel 102 may be a primary dye vessel (PDV) holding a fabric to be dyed and a dye carried by the supercritical fluid for dyeing the fabric.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A spectral monitoring system comprising:
a process vessel defining an internal cavity containing a supercritical fluid;
a sealed window mounted to the process vessel, the window having a line of sight into the internal cavity;
a reflecting mirror disposed in the internal cavity of the process vessel, the mirror axially aligned with the line of sight of the window;
a light source configured to emit sampling light;
a spectrometer configured to process spectral data;
a fiber optic cable comprising light illuminating fibers and light collecting fibers;
a first end of the fiber optic cable disposed adjacent the window; and
a second end of the fiber optic cable being bifurcated between the illuminating fibers optically coupled to the light source and the collecting fibers optically coupled to the spectrometer;
wherein sampling light from the light source passes from the fiber optic cable through the window, strikes and is reflected by the mirror back through window into the fiber optic cable, and is received by the spectrometer for processing

2. The system of accordingly to claim 1, wherein the system is configured such that sampling light is:
emitted by the light source from the first end of the fiber optic cable through the window;
strikes the reflecting mirror,
reflected back to the window and collects spectral data from the supercritical fluid;
received into the first end of the fiber optic cable, and
transmitted to the spectrometer.

3. The system according to claim 1, wherein the reflecting mirror is spaced apart from window.

4. The system according to claim 3, wherein the reflecting mirror is spaced apart by at least one stand-off connected to an interior surface of the process vessel.

5. The system according to claim 1, wherein the reflecting mirror is a spherical mirror.

6. The system according to claim 1, wherein the fiber optic cable extends through a bore formed through a wall of the process vessel.

7. The system according to claim 6, wherein the bore is formed in a threadably removable portion of the wall of the process vessel.

8. The system according to claim 7, wherein the threadably removable portion of the wall formed an entire end cap of the process vessel.

9. The system according to claim 6, wherein the fore is formed in a sidewall of the process vessel.

10. The system according to claim 6, wherein the window is configured to pressure seal the bore.

11. The system according to claim 1, wherein the window is disposed on an interior surface of the process vessel.

12. The system according to claim 1, wherein the process vessel is a fabric dyeing vessel including a fabric disposed in the internal cavity and a dye, the supercritical fluid providing a the carrier for dyeing the fabric.

13. The system according to claim 1, further comprising a computer processor and visual display device operably connected to the spectrometer.

14. The system according to claim 1, wherein the supercritical fluid is carbon dioxide.

15. A spectral monitoring system comprising:
a cylindrical vessel closure having a threaded sidewall configured to removably engage a threaded port formed in a process vessel containing a supercritical fluid;
an axial bore extending through the vessel closure and defining an optical axis;
a sealed window mounted to the vessel closure in axial alignment with the bore;
a reflecting mirror mounted to the vessel closure in spaced apart relationship and axially aligned with the bore and window;
a light source configured to emit sampling light;
a spectrometer configured to receive and process spectral data;
a fiber optic cable comprising light illuminating fibers and light collecting fibers;
a first portion of the fiber optic cable inserted through the axial bore;
a second portion of the fiber optic cable being bifurcated between the illuminating fibers optically coupled to the light source and the collecting fibers optically coupled to the spectrometer;
wherein sampling light from the light source passes from the fiber optic cable through the window, strikes and is reflected by the mirror back through window into the fiber optic cable, and is received by the spectrometer for processing.

16. The system of claim 15, wherein the first portion of the fiber optic cable has an end that abuts the window.

17. The system of claim 15, wherein the reflecting mirror and window are mounted to an interior surface of the vessel closure.

18. The system of claim 15, wherein the window is pressure sealed around the axial bore to the vessel closure.

19. The system of claim 15, wherein the vessel closure forms a removable end wall of the process vessel.

20. The system of claim 15, wherein the axial bore is positioned offset from an axial centerline of the vessel closure.

21. The system according to claim 15, wherein the supercritical fluid is carbon dioxide.

22. A textile dye system with spectral monitoring, the system comprising:
a flow loop comprising a primary dye vessel containing a fabric, a dye recirculation pump, and a secondary dye absorbance monitoring vessel containing a fabric sample for monitoring the color saturation of the fabric;
a supercritical fluid circulating through the flow loop;
a cylindrical vessel closure removably coupled to the primary dye vessel;
an axial bore extending through the vessel closure and defining an optical axis;
a glass window mounted to the vessel closure in axial alignment with the bore;
a reflecting mirror mounted to the vessel closure in spaced apart relationship and axially aligned with the bore and window;
a light source configured to emit sampling light;
a spectrometer configured to receive and process spectral data;
a fiber optic cable comprising light illuminating fibers and light collecting fibers;
a first portion of the fiber optic cable inserted through the axial bore;
a second portion of the fiber optic cable being bifurcated between the illuminating fibers optically coupled to the light source and the collecting fibers optically coupled to the spectrometer;
wherein sampling light from the light source passes from the fiber optic cable through the window, strikes and is reflected by the mirror back through window into the fiber optic cable, and is received by the spectrometer for processing.

23. The system according to claim 22, further comprising a dye take-up vessel fluidly coupled to the flow loop.

24. The system according to claim 22, further comprising a stirred positioned inside the primary dye vessel, the stirred configured and operable to stir the supercritical fluid in the primary dye vessel.

25. The system according to claim 22, wherein the supercritical fluid is carbon dioxide.

26. A method for obtaining spectral data from a supercritical fluid process, the method comprising:
providing a process vessel defining an internal cavity containing a supercritical fluid, a light source emitting sampling light, and a spectrometer;
transmitting the sampling light through a sealed window in the process vessel into the internal cavity;
striking a reflector disposed in the internal cavity with the sampling light;
returning reflected sampling light back through the window in the process vessel, the reflected sampling light containing spectral data from the supercritical fluid;
receiving the reflected sampling light by the spectrometer; and
the spectrometer processing the spectral data.
